(19) United States
(12) Patent Application Publication
(10) Pub. No.: US 2022/0201083 A1
(43) Pub. Date: Jun. 23, 2022

(54) PLATFORM FOR INTEGRATING DISPARATE ECOSYSTEMS WITHIN A VEHICLE

(71) Applicant: CERENCE OPERATING COMPANY, Burlington, MA (US)

(72) Inventors: Prateek KATHPAL, Burlington, MA (US); Brian Arthur RUBIN, Montreal (CA); Holger SCHOLL, Aachen (DE)

(73) Assignee: CERENCE OPERATING COMPANY, Burlington, MA (US)

(21) Appl. No.: 17/554,381

(22) Filed: Dec. 17, 2021

Related U.S. Application Data
(60) Provisional application No. 63/128,952, filed on Dec. 22, 2020.

(51) Int. Cl. H04L 67/125; G10L 15/26; G10L 15/18; G10L 15/22

(52) U.S. Cl. CPC H04L 67/125; G10L 15/26; G16Y 40/30; G10L 15/22; G10L 2015/223; G10L 15/18

(57) ABSTRACT

A system for integrating disparate ecosystems including smart home and internet-of-things (IoT) ecosystems. The system including a vehicle assistant that executes within the context of a cloud-based application and that retrieves sensor data and utterances from a vehicle and forwards the sensor data and passenger-spoken utterances to a cloud-based application. Using the sensor data and utterances, the cloud-based application selects and executes a predetermined routine that includes at least one action to be completed in vehicle, on mobile phone or Smart Home/IoT ecosystem. The action is then complete by issuing the command to the vehicle head-unit, specified mobile phone or target ecosystem selected from a group of disparate ecosystems.

### CROSS-REFERENCE TO RELATED APPLICATIONS

This application claims the benefit of U.S. provisional application Ser. No. 63/128,952 filed Dec. 22, 2020, the disclosure of which is hereby incorporated in its entirety by reference herein.

### TECHNICAL FIELD

Disclosed herein are systems and methods for routing of user commands across disparate Smart Home/IoT ecosystems.

### BACKGROUND

Consumers today are increasingly more connected to their environment whether it be their home, work, or vehicle. For example, smart home devices and systems have become ubiquitous within homes.

Multiple types of devices can be included within a smart home system. For example, a typical system can include smart speakers, smart thermostats, smart doorbells, and smart cameras. In such a system, each device can interact with the other devices and be controlled by a user from a single point of control. Connectivity amongst devices and single-point control can typically be accomplished only when each device within a system is manufactured by a single manufacturer or otherwise specifically configured to integrate. The integrated smart devices together with the smart home system can be called a smart home ecosystem or an internet-of-things (IoT) ecosystem.

Characteristics of an IoT ecosystem are interoperability between devices configured to receive and transmit data over a similar protocol or using a similar application program interface. IoT ecosystems typically have a shared hub comprising at least a management application and data repository for the data obtained from the devices. Additionally, these ecosystems typically require the devices to execute on a particular operating system such as the Android® or iOS® operating system.

IoT ecosystems are designed to restrict the types of devices permitted within the ecosystem. For example, the Google Home ecosystem integrates with Google's Nest products. End users can only achieve interoperability between devices manufactured by the same company. Restricting interoperability in such a way reduces an end user's ability to select a disparate group of devices, instead end users must only buy devices manufactured by the same manufacturer or devices that all use the same communication protocol and/or control application or operating system. Similarly, end users often want to interact with their home ecosystems while they are in the car.

It would therefore be advantageous to provide an integration platform within a vehicle such as a car so that end users can interact with a disparate group of smart home ecosystems from a single control application.

### SUMMARY

Described herein are systems and methods for providing an integration platform within a vehicle, where the integration platform can be used to integrate access to various internet-of-things (IoT) or smart home ecosystems. This access can be provided by an automotive assistant via a cloud-based artificial intelligence (AI). Integrating one or more ecosystems can include being able to invoke and control those ecosystems using a single platform and single point of control.

In addition to providing end users with an integrated platform, the cloud-based AI can also provide end user with the ability to create predetermined routines or cases that carry out an action based on one or more triggers. These predetermined routines are like workflows in that they use various inputs and data to carry out a course of action either in the vehicle, within an end user's personal accounts, in an end user's home or office, or on an end user's mobile device. Unlike other solutions that permit an end user to generate routines using their phone, home and personal accounts, the cloud-based AI can permit the creation of routines that use automotive data and that can be triggered by a vehicle.

Described is a system for integrating disparate ecosystems. The system can include a vehicle assistant that executes within the context of a cloud-based application, and that retrieves sensor data from a vehicle, and at least one utterance spoken by a passenger of the vehicle. The cloud-based application uses at least the sensor data and at least one utterance to execute a predetermined routine that includes at least one ecosystem command. Executing this routine includes issuing the at least one ecosystem command to a target ecosystem selected from a group of disparate ecosystems.

Sensor data can include any one of an identification number for the vehicle, a geographic location of the vehicle, traveling speed of the vehicle, engaged drive gear, vehicle wiper status, a temperature inside and/or outside of the vehicle, a list of passengers residing within the vehicle, date and time information, or voice biometric data for the at least one utterance. The cloud-based application can use the sensor data to select the predetermined routine and execute the selected predetermined routine. The predetermined routine can include a set of conditions and commands.

The group of disparate ecosystems can include smart home ecosystems and/or internet-of-things (IoT) ecosystems.

The system can also include an automatic speech recognition (ASR) module for transcribing the utterance to text, a natural language understanding (NLU) and a natural language processing (NLP) module for interpreting a meaning of the at least one utterance. The cloud-based application can use the text and meaning to identify the predetermined routine.

### BRIEF DESCRIPTION OF THE DRAWINGS

FIG. 1 illustrates a block diagram for a routing system across disparate ecosystems in an automotive application in accordance with one embodiment;

FIG. 2 illustrates an example embodiment of a routing system for routing of user commands across disparate ecosystems;

FIG. 3 illustrates another example embodiment of a routing system for routing of user commands across disparate ecosystems; and

FIG. 4 illustrates an embodiment of a process for answering a user query.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

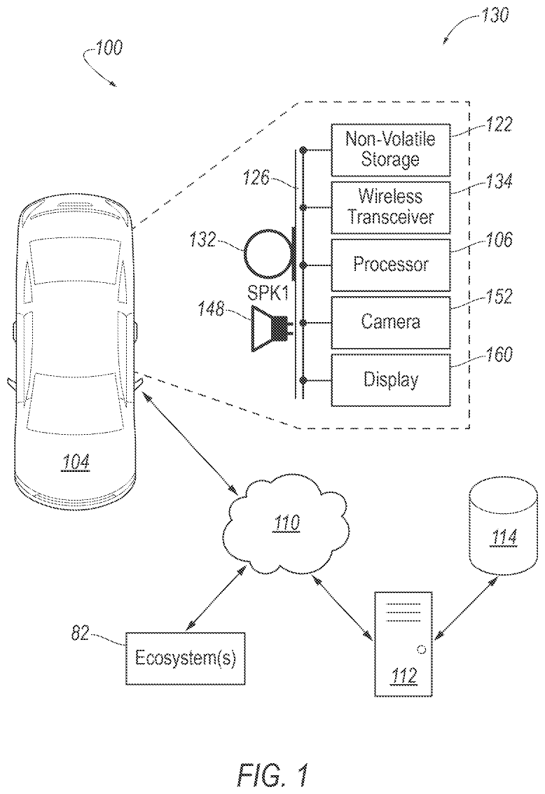

FIG. 1 illustrates block diagram for a routing system across disparate ecosystems in an automotive application in accordance with one embodiment. The routing system 100 may be designed for a vehicle 104 configured to transport passengers. The vehicle 104 may include various types of passenger vehicles, such as crossover utility vehicle (CUV), sport utility vehicle (SUV), truck, motorcycle, recreational vehicle (RV), boat, plane or other mobile machine for transporting people or goods. Further, the vehicle 104 may be autonomous, partially autonomous, self-driving, driverless, or driver-assisted vehicles. The vehicle 104 may be an electric vehicle (EV), such as a battery electric vehicle (BEV), plug-in hybrid electric vehicle (PHEV), hybrid electric vehicle (HEVs), etc.

The vehicle 104 may be configured to include various types of components, processors, and memory, and may communicate with a communication network 110. The communication network 110 may be referred to as a “cloud” and may involve data transfer via wide area and/or local area networks, such as the Internet, Global Positioning System (GPS), cellular networks, Wi-Fi, Bluetooth, etc. The communication network 110 may provide for communication between the vehicle 104 and an external or remote server 112 and/or database 114, as well as other external applications, systems, vehicles, etc. This communication network 110 may provide navigation, music or other audio, program content, marketing content, internet access, speech recognition, cognitive computing, artificial intelligence, to the vehicle 104.

The remote server 112 and the database 114 may include one or more computer hardware processors coupled to one or more computer storage devices for performing steps of one or more methods as described herein and may enable the vehicle 104 to communicate and exchange information and data with systems and subsystems external to the vehicle 104 and local to or onboard the vehicle 104. The vehicle 104 may include one or more processors 106 configured to perform certain instructions, commands and other routines as described herein. Internal vehicle networks 126 may also be included, such as a vehicle controller area network (CAN), an Ethernet network, and a media oriented system transfer (MOST), etc. The internal vehicle networks 126 may allow the processor 106 to communicate with other vehicle 104 systems, such as a vehicle modem, a GPS module and/or Global System for Mobile Communication (GSM) module configured to provide current vehicle location and heading information, and various vehicle electronic control units (ECUs) configured to corporate with the processor 106.

The database 114 may store various records and data associated with certain ecosystems (discussed below) including routines and commands associated with those ecosystems. Actions taken by the predetermined routines may include sending a command to one or more ecosystems; sending an instruction or command to one or more applications or devices in an ecosystem; not taking an action; modifying data stored within the context of an ecosystem; sending an instruction to the vehicle; modifying a navigation route; or any other similar action.

The processor 106 may execute instructions for certain vehicle applications, including navigation, infotainment, climate control, etc. Instructions for the respective vehicle systems may be maintained in a non-volatile manner using a variety of types of computer-readable storage medium 122. The computer-readable storage medium 122 (also referred to herein as memory 122, or storage) includes any non-transitory medium (e.g., a tangible medium) that participates in providing instructions or other data that may be read by the processor 106. Computer-executable instructions may be compiled or interpreted from computer programs created using a variety of programming languages and/or technologies, including, without limitation, and either alone or in combination, Java, C, C++, C#, Objective C, Fortran, Pascal, JavaScript, TypeScript, HTML/CSS, Swift, Kotlin, Python, Perl, and PL/structured query language (SQL).

The processor 106 may also be part of a multimodal processing system 130. The multimodal processing system 130 may include various vehicle components, such as the processor 106, memories, sensors, input devices, displays, etc. The multimodal processing system 130 may include one or more input and output devices for exchanging data processed by the multimodal processing system 130 with other elements shown in FIG. 1. Certain examples of these processes may include navigation system outputs (e.g., time sensitive directions for a driver), incoming text messages converted to output speech, vehicle status outputs, and the like, e.g., output from a local or onboard storage medium or system. In some embodiments, the multimodal processing system 130 provides input/output control functions with respect to one or more electronic devices, such as a heads-up-display (HUD), vehicle display, and/or mobile device of the driver or passenger, sensors, cameras, etc.

The vehicle 104 may include a wireless transceiver 134, such as a BLUETOOTH module, a ZIGBEE transceiver, a Wi-Fi transceiver, an IrDA transceiver, a radio frequency identification (RFID) transceiver, etc.) configured to communicate with compatible wireless transceivers of various user devices, as well as with the communication network 110.

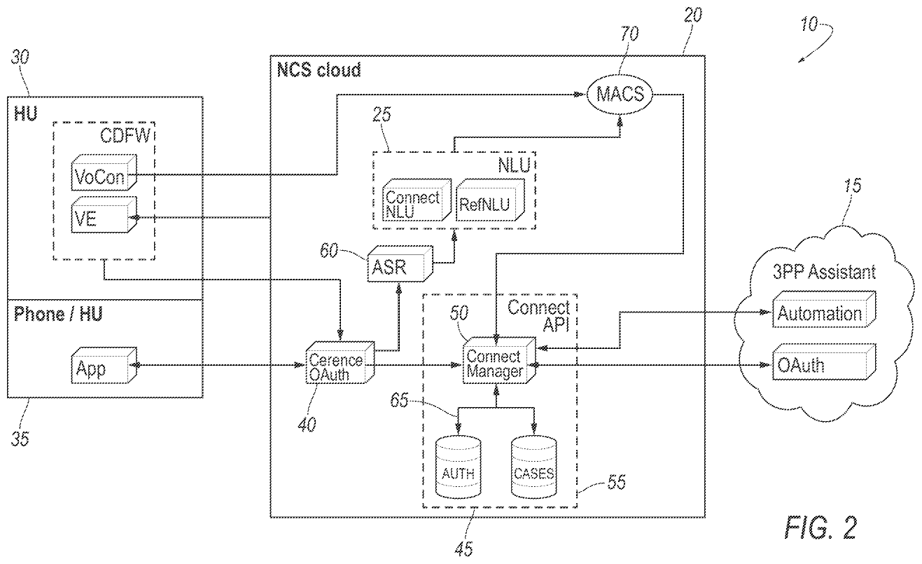

The vehicle 104 may include various sensors and input devices. For example, the vehicle 104 may include at least one microphone 132. The microphone 132 may be configured receive audio signals from within the vehicle cabin, such as acoustic utterances including spoken words, phrases, or commands from a user. The microphone 132 may include an audio input configured to provide audio signal processing features, including amplification, conversions, data processing, etc., to the processor 106. As explained below with respect to FIG. 2, the vehicle 104 may include at least one microphone 132 arranged throughout the vehicle 104. While the microphone 132 is described herein as being used for purposes of the multimodal processing system 130, the microphone 132 may be used for other vehicle features such as active noise cancelation, hands-free interfaces, etc. The microphone 132 may facilitate speech recognition from audio received via the microphone 132 according to grammar associated with available commands, and voice prompt generation. The microphone 132 may include a plurality of microphones 132 arranged throughout the vehicle cabin.

The microphone 132 may be configured to receive audio signals from the vehicle cabin. These audio signals may include occupant utterances, sounds, etc. The microphone 132 may also be used to identify an occupant via directly identification (e.g., a spoken name), or by voice recognition performed by the processor 106. The microphone may also be configured to receive non-occupancy related data such as verbal utterances, etc.

The sensors may include at least one camera configured to provide for facial recognition of the occupant(s). The camera may also be configured to detect non-verbal cues as to the driver's behavior such as the direction of the user's gaze, user gestures, etc. The camera may be a camera capable of taking still images, as well as video and detecting user head, eye, and body movement. The camera may include multiple cameras and the imaging data may be used for qualitative analysis. For example, the imaging data may be used to determine if the user is looking at a certain location or vehicle display. Additionally or alternatively, the imaging data may also supplement timing information as it relates to the user motions or gestures.

The vehicle 104 may include an audio system having audio playback functionality through vehicle speakers 148 or headphones. The audio playback may include audio from sources such as a vehicle radio, including satellite radio, decoded amplitude modulated (AM) or frequency modulated (FM) radio signals, and audio signals from compact disc (CD) or digital versatile disk (DVD) audio playback, streamed audio from a mobile device, commands from a navigation system, etc.

As explained, the vehicle 104 may include various displays and user interfaces, including HUDs, center console displays, steering wheel buttons, etc. Touch screens may be configured to receive user inputs. Visual displays may be configured to provide visual outputs to the user.

The vehicle 104 may include other sensors such as at least one sensor 152. This sensor 152 may be another sensor in addition to the microphone 132, data provided by which may be used to aid in detecting occupancy, such as pressure sensors within the vehicle seats, door sensors, cameras etc. Other sensors may include various biometric sensors and cameras, speedometers, GPS systems, human-machine interface (HMI) controls, video systems, barometers, thermometers (both external and/or internal to the vehicle), odometer, sonars, light detection and ranging sensors (LIDARs), etc. The sensor data may be used to determine other data such as how many occupants are in the vehicle. Each of these sensors may provide the sensor data in order to aid in selecting a target ecosystem and understanding the command. The sensor data may also include vehicle related information such as the vehicle identification number), the type of vehicle, the size of the vehicle, among others.

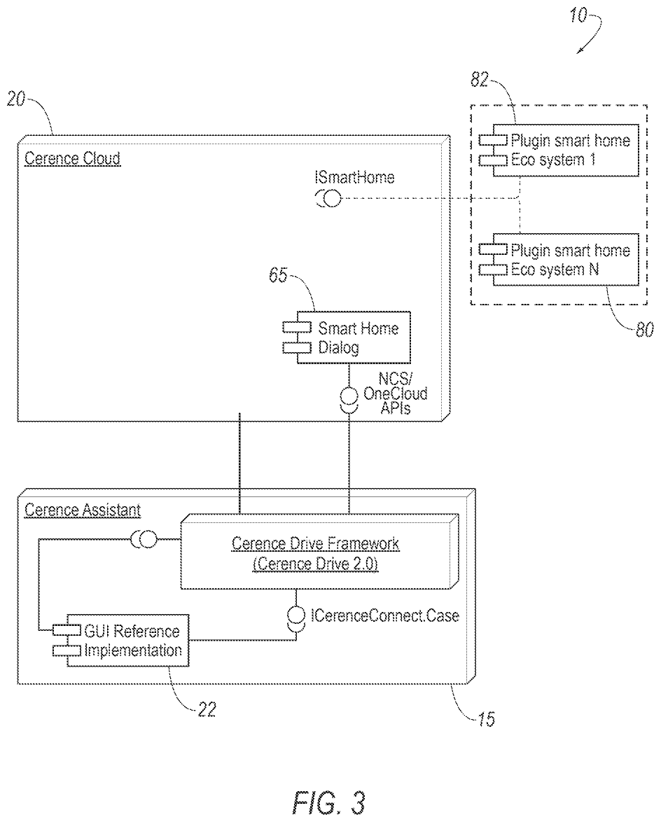

Example ecosystems 82 are also illustrated in FIG. 3 but in general may be non-vehicle systems configured to carry out commands external and remote from the vehicle, such as systems within a user's home, etc.

While an automotive system is discussed in detail here, other applications may be appreciated. For example, similar functionally may also be applied to other, non-automotive cases, e.g. for augmented reality or virtual reality cases with smart glasses, phones, eye trackers in living environment, etc. While the terms “user” is used throughout, this term may be interchangeable with others such as speaker, occupant, etc.

Illustrated in FIG. 2 is an example embodiment of a system 10 for providing an integration platform that can use a vehicle assistant 15 to provide services to passengers within a vehicle. The system 10 may include a head unit (“HU”) 30 arranged within the vehicle. The system 10 may also include a phone or mobile device 35 communicatively linked to the HU 30. The HU 30 and/or the mobile device 35 can be in communication with a cloud-based application 20 that provides functionality to the vehicle assistant 15. Within the cloud-based application 20 is a natural language understanding (“NLU”) module 25, an automatic speech recognition (“ASR”) module 60, and authentication module 40, a connection module 65 and an arbitration engine 70. The connection module 65 can include a connection manager 50, an authentication cache 45 and a cases cache 55.

The HU 30 and/or the mobile device 35 can reside within a vehicle, where a vehicle can be any machine able to transport a person or thing from a first geographical place to a second different geographical place that is separated from the first geographical place by a distance. Vehicles can include, but not be limited to: an automobile or car; a motorbike; a motorized scooter; a two wheeled or three wheeled vehicle; a bus; a truck; an elevator car; a helicopter; a plane; or any other machine used as a mode of transport.

Head units 30 can be the control panel or set of controls within the vehicle that are used to control operation of the vehicle. The HU 30 typically includes one or more processors or micro-processors capable of executing computer readable instructions and may include the display 160 and/or processor 106 of FIG. 1. A vehicle HU 30 can be used to execute one or more applications such as navigation applications, music applications, communication applications, or assistant applications. In some instances, the HU 30 can integrate with one or more mobile devices 35 in the vehicle. In other instances, a phone or mobile device 35 can operate or provide the background applications for the HU 30 such that the HU 30 is a dummy terminal on which the mobile device 35 application is projected. In other instances, the HU 30 can access the data plan or wireless connectivity provided by a mobile device 30 to execute one or more wireless-based applications.

A HU 30 can communicate with a vehicle assistant 15 that can be provided in part by a cloud-based application 20. The cloud-based application 20 may be included in the communication network 110 of FIG. 1 and may provide one or more services to a vehicle either via the vehicle assistant 15 or directly to the HU 30. In some instances, the cloud-based application 20 can execute entirely in a remote location, while in other instances aspects of the cloud-based application 20 can be either cached in the HU 30 or executed locally on the HU 30 and/or mobile device 35. In still other instances, multiple aspects of the cloud-based application 20 can be embedded in the HU 30 and executed thereon.

The cloud-based application 20 can provide natural language understanding (“NLU”) or automatic speech recognition (“ASR”) services. An ASR module 60 can provide the speech recognition system and language models needed to recognize utterances and transcribe them to text. The ASR module 60 can execute entirely within the context of the cloud-based application 20, or aspects of the ASR module 60 can be distributed between the cloud-based application 20 and embedded applications executing on the HU 30. The NLU module 25 provides the NLU applications and NLU models needed to understand the intent and meaning associated with recognized utterances. The NLU module 25 can include models specific to the vehicle assistant 15, or specific to one or more IoT ecosystems. In some embodiments, the cloud-based application 20 can be referred to as a cloud-based artificial intelligence 20, or cloud-based AI. The cloud-based AI 20 can include artificial intelligence and machine learning to modify ASR and NLU modules 60, 25 based on feedback from target ecosystems.

An authentication module 40 can be included within the cloud-based application 20 and can be used to authenticate a user or speaker to any of the cloud-based application 20, the vehicle assistant 15, or a connected IoT ecosystem. The authentication module 40 can perform authentication using any of the following criteria: the VIN (vehicle identification number) of the vehicle; a voice biometric analysis of an utterance; previously provided login credentials; one or more credentials provided to the HU 30 and/or the cloud-based application 20 by the mobile device 35; or any other form of identification. Authentication credentials can be cached within the cloud-based application 20, or in the case of the IoT ecosystems, within the connection module 65.

The connection module 65 can be used to provide access to the vehicle assistant 15 and one or more IoT ecosystems. Within the connection module 65 is a connection manager 50 that manages which IoT ecosystem to connect to. The connection manager 50 can access databases within the connection module 65, including a cache of authentication tokens 45 and a cache of cases 55. Cases 55 may be predetermined workflows that dictate the execution of applications according to a specified timeline and set of contexts. The connection manager 50 can access cases 55 within the cache 45 to determine which IoT ecosystem to connect with and where to send information.

A vehicle assistant 15 can be the interface end users (i.e., passengers and/or drivers) interact with to access IoT ecosystems, send commands to the cloud-based application 20 or Smart Home/IoT ecosystems, or create automation case routines. The vehicle assistant 15 can be referred to as an automotive assistant, an assistant, or the CERENCE Assistant. In some instances, the vehicle assistant 15 can include the CERENCE Drive 2.0 framework which can include one or more applications that provide ASR and NLU services to a vehicle. The vehicle assistant 15 may be an interface configured to integrate different products and applications such as text to speech applications, etc. The vehicle assistant 15 can include a synthetic speech interface and/or a graphical user interface that is displayed within the vehicle.

The system 10 can itself be an integration platform such that requests issued to the cloud-based application 20 via the HU 30 and vehicle assistant 15 are received and forwarded to a target ecosystem 82. Ecosystems can comprise any number of devices, cloud-based storage repositories, or applications. Accessing an ecosystem permits the cloud-based application 20 and thereby the vehicle assistant 15 to interact with devices and applications executing within the ecosystem. It also permits the cloud-based application 20 to access data stored within the context of the ecosystem or modify data within the repository or store new data within the repository. To access an ecosystem, that ecosystem or aspects of the ecosystem are invoked by the cloud-based application 20 using application program interfaces and authentication information stored within the cloud-based application.

Integration can include being able to route commands to multiple types of ecosystems, and can also include creating predetermined routines that access, invoke, and control available ecosystems. These predetermined routines can be referred to as cases, scenarios, applets or routines and they are defined by end users or iteratively using AI within the cloud-based application 20. The routines may be stored within the databases of the cache 45 and a cases cache 55, or the database 114 of FIG. 1. Actions taken by the predetermined routines can include: sending a command to one or more ecosystems; sending an instruction or command to one or more applications or devices in an ecosystem; not taking an action; modifying data stored within the context of an ecosystem; sending an instruction to the vehicle; modifying a navigation route; or any other similar action.

For example, an end user can create a predetermined routine that is triggered on one or multiple triggers such as the time of day, day of the week, and distance to a driver's house. The predetermined routine, based on these triggers or data, can send out a call to a restaurant, order a previously ordered meal, having it delivered and paid for, and turn on the outside house lights for the delivery person. In another example, a predetermined routine could calculate a distance to work and determine an estimated time of arrival, then access a work calendar and move an in-person meeting to accommodate a late estimated time of arrival (ETA).

Predetermined routines can be generated by end users using the vehicle assistant 15 or by directly accessing the cloud-based application 20. As explained, these routines may be stored in the database 114 or within the cloud-based application 20.

The “modules” discussed herein may include one or more computer hardware processors coupled to one or more computer storage devices for performing steps of one or more methods as described herein and may enable the system 10 to communicate and exchange information and data with systems and subsystems. The modules, vehicle, cloud AI, HU 30, mobile device 35, and vehicle assistant 15, among other components may include one or more processors configured to perform certain instructions, commands and other routines as described herein. Internal vehicle networks may also be included, such as a vehicle controller area network (CAN), an Ethernet network, and a media oriented system transfer (MOST), etc. The internal vehicle networks may allow the processor to communicate with other vehicle systems, such as a vehicle modem, a GPS module and/or Global System for Mobile Communication (GSM) module configured to provide current vehicle location and heading information, and various vehicle electronic control units (ECUs) configured to corporate with the processor.

Referring to FIG. 3, the system 10 includes the vehicle assistant 15, cloud-based application 20, and ecosystem application programming interfaces (APIs) 80. The ecosystem APIs 80 may correspond to various ecosystems 82. As explained above, the ecosystems 82 may include various smart systems outsides of the vehicle systems such as personal assistant devices, home automation systems, etc. In some example, the ecosystems may include Google® Home and SimpliSafe® ecosystems, Alexa® Home System, etc. The cloud-based application 20 can include a configuration management service (not shown) that permits end users to on-board Smart Home and/or IoT ecosystems. These ecosystems can be a home automation ecosystem or any other ecosystem that permits wireless-enabled devices to interoperate, communicate with each other, and be controlled by a single application or control point. The system 10 can provide end-users (i.e., car manufacturer OEMs, and/or car owners/users) with the ability to access multiple Smart Home and/or IoT ecosystems. For example, an end user can choose to access the Google® Home and SimpliSafe® ecosystems. In the future, if the end user wants to access the Alexa® Home System, the end user can use the configuration management service to on-board the Alexa® Home System ecosystem. This may be done, for instance, by establishing a connection with the specific device and the cloud-based application 20 so that the cloud-based application 20 may communicate with the ecosystem. This may be done in a set up mode via a user interface on the mobile device 35, or via an interface within the vehicle.

In some instances, the configuration management service can include a storage repository for storing configuration profiles, an application program interface (API) for providing an end-user with the ability to on-board new ecosystems, and various backend modules for configuring access to an ecosystem. On-boarding and establishing a connection with an ecosystem requires access to that ecosystem's API or suite of APIs 80. The cloud-based application 20 includes an API access module that provides an interface between the cloud-based application 20 and the ecosystem API(s) 80.

The vehicle assistant 15 can be a front end to the cloud-based application 20 such that the vehicle assistant 15 receives utterances and serves them to the cloud-based application 20 for processing.

The vehicle assistant 15 can also manage authentication and can receive or facilitate forwarding vehicle sensor data to the cloud-based application 20. As explained above, the sensor data may be received by the sensors 152 of the system 130 in FIG. 1, as well as other vehicle components. In addition to the examples above, vehicle sensor data can include: the speed of the vehicle; the temperature in the vehicle; the temperature outside the vehicle; the geographic location of the vehicle; the direction of travel of the vehicle; an identification number of the vehicle (i.e., the vehicle identification number); the type of vehicle; the size of the vehicle; the number of passengers in the vehicle; whether the vehicle's driver/operator is alert; the weather conditions within which the vehicle is traveling; whether the vehicle's wheels are slipping; the distance from the vehicle to one or more points of interest (e.g., home, office, shopping center, vacation home); voice biometrics for one or more speakers within the vehicle; or any other sensor or environmental information. This vehicle sensor and environment information/data can be used by the cloud-based application 20 to select target ecosystems, create new predetermined routines, select predetermined routines, and modify the operation of a command by a device or application within an ecosystem.

For example, the vehicle assistant 15 can receive an utterance and send the utterance to the cloud-based application 20 for processing. The utterance may be received by the microphone 132, as illustrated in FIG. 1. Within the cloud-based application 20, the ASR module 60 uses ASR applications and language models to translate the utterance to text.

In some instances, the vehicle assistant 15 can also access information stored within one of the disparate ecosystems. For example, the vehicle assistant 15 can access information about the home or environment where a smart home ecosystem is installed and send that information to the cloud-based application 20. The cloud-based application 20 can use this home or environment information to further trigger or start a predetermined routine, modify an existing routine, or create a new routine. Such information may be stored within the database 114 of within the ecosystems 82 themselves.

The NLU module 25 then uses the translated text of the utterance and various other types of information to determine the intent of the utterance. Other types of information or utterance data may be contextual data indicative of non-audio contextual circumstances of the vehicle or driver. The contextual data may include, but not be limited to: the time of day; the day of the week; the month; the weather; the temperature; where the vehicle is geographically located; how far away the vehicle is located from a significant geographic location such as the home of the driver; whether there are additional occupants in the vehicle; the vehicle's identification number; the biometric identity of the person who spoke the utterance; the location of the person who spoke the utterance within the vehicle; the speed at which the vehicle is traveling; the direction of the driver's gaze; whether the driver has an elevated heart rate or other significant biofeedback; the amount of noise in the cabin of the vehicle; or any other relevant contextual information. Using this information, the NLU module 25 can determine whether the utterance included a command and to which ecosystem the command is directed.

For example, a driver of an automobile can say “turn on the lights”. The vehicle assistant 15 can send this utterance to the cloud-based application 20 where the utterance is translated by the ASR module 60 to be “turn on the lights”. The NLU module 25 can then use the fact that it is five o'clock at night, half a mile from the driver's home to know that the command should be sent to the driver's Alexa® Home System. The cloud-based application 20 can then send the command to the driver's Alexa® Home System and receive a confirmation from the driver's Alexa® Home System that the command was received and executed. Based on this received confirmation, the cloud-based application 20 can update the NLU/NLP models of the NLU module 25 to increase the certainty around the determination that when the driver of the car is a half mile from their house at five o'clock at night and utters the phrase “turn on the lights”, the utterance means that the cloud-based application 20 should instruct the driver's Alexa® Home System to turn on the lights.

In another example, a driver of an automobile can say “lock the doors”. The vehicle assistant 15 can send this utterance to the cloud-based application 20 where the utterance is translated by the ASR module 60 to be “lock the doors”. The NLU module 25 can then use the fact that the driver is more than ten miles from home to determine that the command should be sent to the driver's SimpliSafe® system. The cloud-based application 20 can then send the command to the driver's SimpliSafe® system and receive a confirmation from the driver's SimpliSafe® system that the command was received and not executed. Based on this received confirmation, the cloud-based application 20 can update the NLU/NLP models of the NLU module 25 so that when a “lock the doors” command is received, the command is not sent to the driver's SimpliSafe® system.

In one instance, the system 10 can be used to provide input to passengers in the vehicle or the vehicle from one or more ecosystems or devices within an ecosystem.

For example, when the user starts the vehicle and starts driving, the Geo-location will be provided to the CERENCE Connect in addition to the fact that the car just started driving. At this point the CERENCE Connect application will check if there are any notifications from any devices attached to the user's home graph and send all notifications to the vehicle's head unit. One of these notifications may be a signal showing that the refrigerator door was left open. Then based on user's notification settings CERENCE Connect may play a prompt in the vehicle announcing that the refrigerator door was left open.

Thus, the vehicle assistant 15 can be the interface that end users (i.e., passengers and/or drivers) interact with to access IoT ecosystems 82, send commands to the cloud-based application 20 or IoT ecosystems 82, or create cases. The vehicle assistant 15 can be referred to as an automotive assistant, an assistant, or the CERENCE Assistant. In some instances, the vehicle assistant 15 can include the CERENCE Drive 2.0 framework 18 which can include one or more applications that provide ASR and NLU services to a vehicle. The vehicle assistant 15 may be an interface configured to integrate different products and applications such as text to speech applications, etc. The vehicle assistant 15 can include a synthetic speech interface and/or a graphical user interface 22 that is displayed within the vehicle.

The user interface 22 may be configured to display information relating to the target ecosystem. For example, once the ecosystem is selected, the user interface 22 may display an image or icon associated with that ecosystem 82. The user interface 22 may also display a confirmation that the target ecosystem 82 received the command and also when the ecosystem 82 has carried out the command. The user interface 22 may also display a lack of response, or other alerts, to the command by the ecosystem 82 as well.

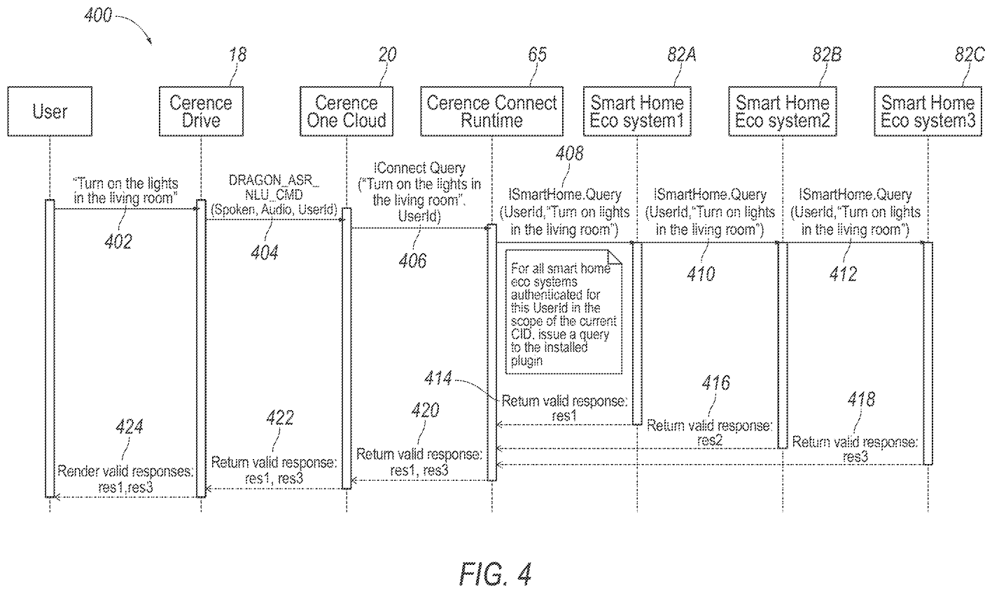

Illustrated in FIG. 4 is an example of a process flow 400 by which a user query can be answered. At step 402, the user may utter a phrase such as, for example, “turn on the lights in the living room” while riding in a vehicle. This information can be passed to an application executing within the vehicle assistant 15 (e.g., CERENCE Drive 18 framework) where the utterance and identifying information about the user is included in the information passed along. The information may also contain the sensor data, among other information. The vehicle assistant 15 further passes the information along to the cloud-based application 20 at step 404, where the utterance is transcribed to text, an intent or meaning is ascribed to the utterance, and the user identifying information is used to authenticate the user to the cloud-based application 20 and one or many ecosystems. This is based at least in part on the utterance itself. Additionally, the sensor data or other vehicle or user data may also be used to ascribe the meaning.

At step 406, using the transcribed text and ascribed meaning of the utterance, the cloud-based application 20 selects an ecosystem from among a group of ecosystems (i.e., the target ecosystem) and at step 408 sends, via the connection module 65, a command or set of commands and data to a first of the target ecosystems 82. The commands may be transmitted to one or a plurality of ecosystems 82. In the example shown in FIG. 3, three separate ecosystems 82 are illustrated, including a first ecosystem 82a, a second ecosystem 82b, and a third ecosystem 83c. As explained above, each ecosystem 82 may correspond to a specific non-vehicle system configured to carry out commands external and remote from the vehicle, such as systems within a user's home, etc. Initially, a command is transmitted to the first ecosystem 82a at step 408.

At step 414, the cloud-based application 20 receives feedback from the first ecosystem 82a. The feedback may identify whether the command(s) and/or data were accepted by the target ecosystem 82. If the target ecosystem did not accept the command(s) and/or data, the cloud-based application 20 may send the command(s) and data to the second target ecosystem 82b at step 410, and forward the feedback at step 416. This process continues iteratively until the correct target ecosystem is selected (e.g., sending commands to the third target ecosystem 82c at step 412 and forwarding the feedback at step 418). Valid responses may be forwarded as appropriate at steps 420, 422 and 424.

Computing devices described herein generally include computer-executable instructions where the instructions may be executable by one or more computing devices such as those listed above. Computer-executable instructions, such as those of the virtual network interface application 202 or virtual network mobile application 208, may be compiled or interpreted from computer programs created using a variety of programming languages and/or technologies, including, without limitation, and either alone or in combination, Java™, C, C++, C#, Visual Basic, JavaScript, Python, TypeScript, HTML/CSS, Swift, Kotlin, Perl, PL/SQL, Prolog, LISP, Corelet, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The abstract of the disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system for integrating disparate ecosystems, the system comprising:
a vehicle assistant executing within a cloud-based application, the vehicle assistant configured to retrieve sensor data from a vehicle, and at least one utterance spoken by a passenger of the vehicle; and
the cloud-based application receiving the sensor data and the at least one utterance from the vehicle assistant and using the sensor data and the at least one utterance to execute a predetermined routine comprising at least one ecosystem command,
wherein the cloud-based application executes the predetermined routine by issuing the at least one ecosystem command to a target ecosystem selected from a group of disparate ecosystems.

2. The system of claim 1, wherein the sensor data comprises one or more of an identification number for the vehicle, a geographic location of the vehicle, a temperature outside of the vehicle, a list of passengers residing within the vehicle, date and time information, or voice biometric data for the at least one utterance.

3. The system of claim 1, wherein the cloud-based application uses the sensor data to select the predetermined routine and execute the selected predetermined routine.

4. The system of claim 1, wherein the predetermined routine comprises a set of conditions and commands.

5. The system of claim 1, wherein the group of disparate ecosystems comprises smart home ecosystems.

6. The system of claim 1, wherein the group of disparate ecosystems comprises internet-of-things ecosystems.

7. The system of claim 1, further comprising:
an automatic speech recognition module for transcribing the utterance to text; and
a natural language processing module for interpreting a meaning of the at least one utterance,
wherein the cloud-based application uses the text and meaning to identify the predetermined routine.

8. A method for routing commands to a target ecosystem, the method comprising:
receiving one or more utterances comprising at least one command;
receiving sensor data indicative of at least one vehicle circumstance of a vehicle;
selecting a target ecosystem based on the one or more utterances and the sensor data; and
transmitting the one or more utterances to the target ecosystem for the target ecosystem to carry out the command.

9. The method of claim 8, wherein the sensor data includes at least one of an identification number for a vehicle, a geographic location of the vehicle, a temperature outside of the vehicle, a list of passengers residing within the vehicle, date and time information, and voice biometric data for the one or more utterances.

10. The method of claim 8, further comprising selecting a predetermined routine based on the one or more utterances and the sensor data.

11. The method of claim 10, wherein the predetermined routine includes a set of conditions and commands specific to the target ecosystem.

12. The method of claim 8, wherein the target ecosystem includes a smart home system.

13. The method of claim 8, further comprising translating the one or more utterances to text and determining a probable meaning of the text in order to select the target ecosystem.

14. The method of claim 13, further comprising interpreting the meaning of the text via a natural language understanding module.

15. The method of claim 8, further comprising instructing a user interface to display an indication of the target ecosystem in response to determining the target ecosystem.

16. The method of claim 8, further comprising authenticating the target ecosystem via an authorization token stored in a cloud database.

17. The method of claim 8, wherein the target ecosystem is a non-vehicle system configured to carry out commands external and remote from the vehicle.

18. A system for routing commands from a vehicle to at least one disparate ecosystem, the system comprising:
a memory configured to maintain predetermined routines for running at certain ecosystems; and
a cloud based application configured to
receive an utterance comprising at least one command from a vehicle occupant,
receive sensor data indicative of a vehicle circumstance,
process the utterance, and
select a target ecosystem for which the at least one command is intended based on the utterance and the sensor data,
selecting one of the predetermined routines associated with the selected target ecosystem, and
transmitting the utterance to the selected target ecosystem to carry out the command.

19. The system of claim 18, wherein the sensor data includes at least one of an identification number for the vehicle, a geographic location of the vehicle, a temperature outside of the vehicle, a list of passengers residing within the vehicle, date and time information, and voice biometric data for the utterance.

20. The system of claim 18, wherein the selected one of the predetermined routines includes a set of conditions and commands specific to the target ecosystem.
